(19) United States
(12) Patent Application Publication
(10) Pub. No.: US 2018/0326899 A1
(43) Pub. Date: Nov. 15, 2018

(54) ILLUMINATED HINGE ASSEMBLY

(71) Applicant: Ford Global Technologies, LLC, Dearborn, MI (US)

(72) Inventors: Stuart C. Salter, White Lake, MI (US); Pietro Buttolo, Dearborn Heights, MI (US); Paul Kenneth Dellock, Northville, MI (US); Cornel Lewis Gardner, Romulus, MI (US)

(73) Assignee: Ford Global Technologies, LLC

(21) Appl. No.: 15/591,167

(22) Filed: May 10, 2017

(51) Int. Cl. B60Q 3/70; E05D 3/02; E05D 11/00; E05D 5/10; E05D 9/00; B60Q 3/20; B60Q 3/54; B62D 65/00; B60Q 3/60

(52) U.S. Cl. CPC B60Q 3/70; E05D 3/02; E05D 11/00; E05D 11/0081; E05D 5/10; E05D 9/00; B60Q 2500/10; B60Q 3/54; B62D 65/00; B60Q 3/60; E05Y 2900/531; E05D 2005/104; B60Q 3/20

(57) ABSTRACT

An illumination system includes a light assembly configured to emit light. A hinge assembly is positioned away from the light assembly. A frame bracket, a door bracket and a hinge pin rotatably couple the frame and door brackets. A luminescent structure is positioned on the hinge assembly.

### FIELD OF THE INVENTION

The present disclosure generally relates to hinge assemblies, and more particularly, to illuminated hinge assemblies.

### BACKGROUND OF THE INVENTION

Illumination arising from the use of photoluminescent structures offers a unique and attractive viewing experience. It is therefore desired to implement such structures in automotive vehicles for various lighting applications.

### SUMMARY OF THE INVENTION

According to one aspect of the present disclosure, an illumination system includes a light assembly configured to emit light. A hinge assembly is positioned away from the light assembly. A frame bracket, a door bracket and a hinge pin rotatably couples the frame and door brackets. A luminescent structure is positioned on the hinge assembly.

According to another aspect of the present disclosure, a vehicle includes a hinge assembly rotatably coupling a vehicle door to a frame of the vehicle. A photoluminescent structure is positioned on the hinge assembly. A light assembly is positioned proximate the door and configured to illuminate the photoluminescent structure.

According to yet another aspect of the present disclosure, a method of removing a door, includes the steps: transitioning a door of a vehicle from a closed to an open position, activating a light assembly to emit a beam of light and steering the beam of light to illuminate a hinge assembly coupling the door and a frame of the vehicle.

These and other aspects, objects, and features of the present disclosure will be understood and appreciated by those skilled in the art upon studying the following specification, claims, and appended drawings.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1A is a side view of a photoluminescent structure rendered as a coating for use in an assembly according to one embodiment;

FIG. 1B is a top view of a photoluminescent structure rendered as a discrete particle according to one embodiment;

FIG. 1C is a side view of a plurality of photoluminescent structures rendered as discrete particles and incorporated into a separate structure;

FIG. 2 is a rear perspective view of a vehicle, according to at least one example;

FIG. 3A is an interior perspective view of a vehicle, according to at least one example;

FIG. 3B is an interior perspective view of a vehicle, according to at least one example;

FIG. 4 is an interior perspective view of a vehicle, according to at least one example;

FIG. 5 is a flow diagram, according to at least one example; and

FIG. 6 is a block diagram of the vehicle, according to at least one example.

### DETAILED DESCRIPTION OF THE PREFERRED EMBODIMENTS

Additional features and advantages of the invention will be set forth in the detailed description which follows and will be apparent to those skilled in the art from the description, or recognized by practicing the invention as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

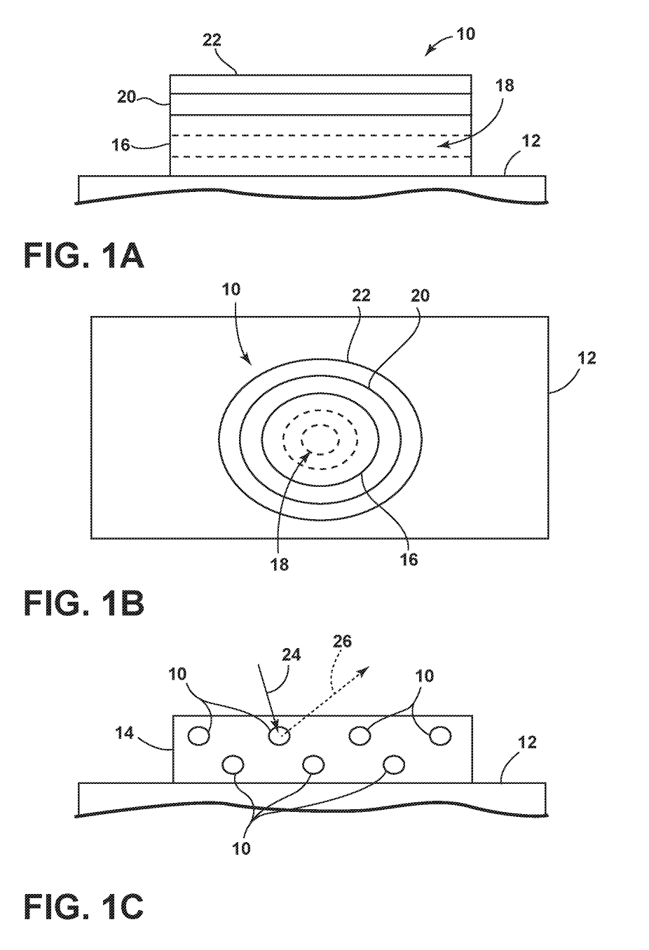

Referring to FIGS. 1A-1C, various exemplary embodiments of photoluminescent structures 10 are shown, each capable of being coupled to a substrate 12, which may correspond to a vehicle fixture or vehicle-related piece of equipment. In FIG. 1A, the photoluminescent structure 10 is generally shown rendered as a coating (e.g., a film) that may be applied to a surface of the substrate 12. In FIG. 1B, the photoluminescent structure 10 is generally shown as a discrete particle capable of being integrated with a substrate 12. In FIG. 1C, the photoluminescent structure 10 is generally shown as a plurality of discrete particles that may be incorporated into a support medium 14 (e.g., a film) that may then be applied (as shown) or integrated with the substrate 12.

At the most basic level, a given photoluminescent structure 10 includes an energy conversion layer 16 that may include one or more sublayers, which are exemplarily shown through broken lines in FIGS. 1A and 1B. Each sublayer of the energy conversion layer 16 may include one or more photoluminescent materials 18 having energy converting elements with phosphorescent or fluorescent properties. Each photoluminescent material 18 may become excited upon receiving an excitation light 24 of a specific wavelength, thereby causing the light to undergo a conversion process. Under the principle of down conversion, the excitation light 24 is converted into a longer wavelength, converted light 26, that is outputted from the photoluminescent structure 10. Conversely, under the principle of up conversion, the excitation light 24 is converted into a shorter wavelength light that is outputted from the photoluminescent structure 10. When multiple distinct wavelengths of light are outputted from the photoluminescent structure 10 at the same time, the wavelengths of light may mix together and be expressed as a multicolor light.

Light emitted by the sun, ambient sources and/or a light source is referred to herein as excitation light 24 and is illustrated herein as solid arrows. In contrast, light emitted from the photoluminescent structure 10 is referred to herein as converted light 26 and is illustrated herein as broken arrows. The mixture of excitation light 24 and converted light 26 that may be emitted simultaneously is referred to herein as outputted light.

The energy conversion layer 16 may be prepared by dispersing the photoluminescent material 18 in a polymer matrix to form a homogenous mixture using a variety of methods. Such methods may include preparing the energy conversion layer 16 from a formulation in a liquid carrier support medium 14 and coating the energy conversion layer 16 to a desired substrate 12. The energy conversion layer 16 may be applied to a substrate 12 by painting, screen-printing, spraying, slot coating, dip coating, roller coating, and bar coating. Alternatively, the energy conversion layer 16 may be prepared by methods that do not use a liquid carrier support medium 14. For example, the energy conversion layer 16 may be rendered by dispersing the photoluminescent material 18 into a solid-state solution (homogenous mixture in a dry state) that may be incorporated in a polymer matrix, which may be formed by extrusion, injection molding, compression molding, calendaring, thermoforming, etc. The energy conversion layer 16 may then be integrated into a substrate 12 using any methods known to those skilled in the art. When the energy conversion layer 16 includes sublayers, each sublayer may be sequentially coated to form the energy conversion layer 16. Alternatively, the sublayers can be separately prepared and later laminated or embossed together to form the energy conversion layer 16. Alternatively still, the energy conversion layer 16 may be formed by coextruding the sublayers.

In some examples, the converted light 26 that has been down converted or up converted may be used to excite other photoluminescent material(s) 18 found in the energy conversion layer 16. The process of using the converted light 26 outputted from one photoluminescent material 18 to excite another, and so on, is generally known as an energy cascade and may serve as an alternative for achieving various color expressions. With respect to either conversion principle, the difference in wavelength between the excitation light 24 and the converted light 26 is known as the Stokes shift and serves as the principal driving mechanism for an energy conversion process corresponding to a change in wavelength of light. In the various embodiments discussed herein, each of the photoluminescent structures 10 may operate under either conversion principle.

Referring back to FIGS. 1A and 1B, the photoluminescent structure 10 may optionally include at least one stability layer 20 to protect the photoluminescent material 18 contained within the energy conversion layer 16 from photolytic and thermal degradation. The stability layer 20 may be configured as a separate layer optically coupled and adhered to the energy conversion layer 16. Alternatively, the stability layer 20 may be integrated with the energy conversion layer 16. The photoluminescent structure 10 may also optionally include a protective layer 22 optically coupled and adhered to the stability layer 20 or other layer (e.g., the conversion layer 16 in the absence of the stability layer 20) to protect the photoluminescent structure 10 from physical and chemical damage arising from environmental exposure. The stability layer 20 and/or the protective layer 22 may be combined with the energy conversion layer 16 through sequential coating or printing of each layer, sequential lamination or embossing, or any other suitable means.

Additional information regarding the construction of photoluminescent structures 10 is disclosed in U.S. Pat. No. 8,232,533 to Kingsley et al., entitled “PHOTOLYTICALLY AND ENVIRONMENTALLY STABLE MULTILAYER STRUCTURE FOR HIGH EFFICIENCY ELECTROMAGNETIC ENERGY CONVERSION AND SUSTAINED SECONDARY EMISSION,” the entire disclosure of which is incorporated herein by reference. For additional information regarding fabrication and utilization of photoluminescent materials to achieve various light emissions, refer to U.S. Pat. No. 8,207,511 to Bortz et al., entitled “PHOTOLUMINESCENT FIBERS, COMPOSITIONS AND FABRICS MADE THEREFROM”; U.S. Pat. No. 8,247,761 to Agrawal et al., entitled “PHOTOLUMINESCENT MARKINGS WITH FUNCTIONAL OVERLAYERS”; U.S. Pat. No. 8,519,359 to Kingsley et al., entitled “PHOTOLYTICALLY AND ENVIRONMENTALLY STABLE MULTILAYER STRUCTURE FOR HIGH EFFICIENCY ELECTROMAGNETIC ENERGY CONVERSION AND SUSTAINED SECONDARY EMISSION”; U.S. Pat. No. 8,664,624 to Kingsley et al., entitled “ILLUMINATION DELIVERY SYSTEM FOR GENERATING SUSTAINED SECONDARY EMISSION”; U.S. Patent Publication No. 2012/0183677 to Agrawal et al., entitled “PHOTOLUMINESCENT COMPOSITIONS, METHODS OF MANUFACTURE AND NOVEL USES”; U.S. Pat. No. 9,057,021 to Kingsley et al., entitled “PHOTOLUMINESCENT OBJECTS”; and U.S. Pat. No. 8,846,184 to Agrawal et al., entitled “CHROMIC LUMINESCENT OBJECTS,” all of which are incorporated herein by reference in their entirety.

According to one embodiment, the photoluminescent material 18 may include organic or inorganic fluorescent dyes including rylenes, xanthenes, porphyrins, and phthalocyanines. Additionally, or alternatively, the photoluminescent material 18 may include phosphors from the group of Ce-doped garnets such as YAG:Ce and may be a short persistence photoluminescent material 18. For example, an emission by Ce³⁺ is based on an electronic energy transition from 4D¹ to 4f¹ as a parity allowed transition. As a result of this, a difference in energy between the light absorption and the light emission by Ce³⁺ is small, and the luminescent level of Ce³⁺ has an ultra-short lifespan, or decay time, of 10⁻⁸ to 10⁻⁷ seconds (10 to 100 nanoseconds). The decay time may be defined as the time between the end of excitation from the excitation light 24 and the moment when the light intensity of the converted light 26 emitted from the photoluminescent structure 10 drops below a minimum visibility of 0.32 mcd/m². A visibility of 0.32 mcd/m² is roughly 100 times the sensitivity of the dark-adapted human eye, which corresponds to a base level of illumination commonly used by persons of ordinary skill in the art.

According to one embodiment, a Ce³⁺ garnet may be utilized, which has a peak excitation spectrum that may reside in a shorter wavelength range than that of conventional YAG:Ce-type phosphors. Accordingly, Ce³⁺ has short persistence characteristics such that its decay time may be 100 milliseconds or less. Therefore, in some embodiments, the rare earth aluminum garnet type Ce phosphor may serve as the photoluminescent material 18 with ultra-short persistence characteristics, which can emit the converted light 26 by absorbing purple to blue excitation light 24 emitted from a light source and/or ambient sources. According to one embodiment, a ZnS:Ag phosphor may be used to create a blue converted light 26. A ZnS:Cu phosphor may be utilized to create a yellowish-green converted light 26. A Y₂O₂S:Eu phosphor may be used to create red converted light 26. Moreover, the aforementioned phosphorescent materials may be combined to form a wide range of colors, including white light. It will be understood that any short persistence photoluminescent material known in the art may be utilized without departing from the teachings provided herein. Additional information regarding the production of short persistence photoluminescent materials is disclosed in U.S. Pat. No. 8,163,201 to Agrawal et al., entitled “PHOTOLYTICALLY AND ENVIRONMENTALLY STABLE MULTILAYER STRUCTURE FOR HIGH EFFICIENCY ELECTROMAGNETIC ENERGY CONVERSION AND SUSTAINED SECONDARY EMISSION,” the entire disclosure of which is incorporated herein by reference.

Additionally, or alternatively, the photoluminescent material 18, according to one embodiment, disposed within the photoluminescent structure 10 may include a long persistence photoluminescent material 18 that emits the converted light 26, once charged by the excitation light 24. The excitation light 24 may be emitted from any excitation source (e.g., any natural light source, such as the sun, and/or any artificial light source). The long persistence photoluminescent material 18 may be defined as having a long decay time due to its ability to store the excitation light 24 and release the converted light 26 gradually, for a period of several minutes or hours, once the excitation light 24 is no longer present.

The long persistence photoluminescent material 18, according to one embodiment, may be operable to emit light at or above an intensity of 0.32 mcd/m² after a period of 10 minutes. Additionally, the long persistence photoluminescent material 18 may be operable to emit light above or at an intensity of 0.32 mcd/m² after a period of 30 minutes and, in some embodiments, for a period substantially longer than 60 minutes (e.g., the period may extend 24 hours or longer, and in some instances, the period may extend 48 hours). Accordingly, the long persistence photoluminescent material 18 may continually illuminate in response to excitation from any light sources that emit the excitation light 24, including, but not limited to, natural light sources (e.g., the sun) and/or any artificial light source. The periodic absorption of the excitation light 24 from any excitation source may provide for a substantially sustained charge of the long persistence photoluminescent material 18 to provide for consistent passive illumination. In some embodiments, a light sensor may monitor the illumination intensity of the photoluminescent structure 10 and actuate an excitation source when the illumination intensity falls below 0.32 mcd/m², or any other predefined intensity level.

The long persistence photoluminescent material 18 may correspond to alkaline earth aluminates and silicates, for example doped di-silicates, or any other compound that is capable of emitting light for a period of time once the excitation light 24 is no longer present. The long persistence photoluminescent material 18 may be doped with one or more ions, which may correspond to rare earth elements, for example, Eu²⁺, Tb³⁺ and/or Dy³. According to one non-limiting exemplary embodiment, the photoluminescent structure 10 includes a phosphorescent material in the range of about 30% to about 55%, a liquid carrier medium in the range of about 25% to about 55%, a polymeric resin in the range of about 15% to about 35%, a stabilizing additive in the range of about 0.25% to about 20%, and performance-enhancing additives in the range of about 0% to about 5%, each based on the weight of the formulation.

The photoluminescent structure 10, according to one embodiment, may be a translucent white color, and in some instances reflective, when unilluminated. Once the photoluminescent structure 10 receives the excitation light 24 of a particular wavelength, the photoluminescent structure 10 may emit any color light (e.g., blue or red) therefrom at any desired brightness. According to one embodiment, a blue-emitting phosphorescent material may have the structure Li₂ZnGeO₄ and may be prepared by a high temperature solid-state reaction method or through any other practicable method and/or process. The afterglow may last for a duration of 2-8 hours and may originate from the excitation light 24 and d-d transitions of Mn²⁺ ions.

According to an alternate non-limiting exemplary embodiment, 100 parts of a commercial solvent-borne polyurethane, such as Mace resin 107-268, having 50% solids polyurethane in toluene/isopropanol, 125 parts of a blue-green long persistence phosphor, such as Performance Indicator PI-BG20, and 12.5 parts of a dye solution containing 0.1% Lumogen Yellow F083 in dioxolane may be blended to yield a low rare earth mineral photoluminescent structure 10. It will be understood that the compositions provided herein are non-limiting examples. Thus, any phosphor known in the art may be utilized within the photoluminescent structure 10 without departing from the teachings provided herein. Moreover, it is contemplated that any long persistence phosphor known in the art may also be utilized without departing from the teachings provided herein.

Additional information regarding the production of long persistence photoluminescent materials is disclosed in U.S. Pat. No. 8,163,201 to Agrawal et al., entitled “HIGH-INTENSITY, PERSISTENT PHOTOLUMINESCENT FORMULATIONS AND OBJECTS, AND METHODS FOR CREATING THE SAME,” the entire disclosure of which is incorporated herein by reference. For additional information regarding long persistence phosphorescent structures, refer to U.S. Pat. No. 6,953,536 to Yen et al., entitled “LONG PERSISTENT PHOSPHORS AND PERSISTENT ENERGY TRANSFER TECHNIQUE”; U.S. Pat. No. 6,117,362 to Yen et al., entitled “LONG-PERSISTENT BLUE PHOSPHORS”; and U.S. Pat. No. 8,952,341 to Kingsley et al., entitled “LOW RARE EARTH MINERAL PHOTOLUMINESCENT COMPOSITIONS AND STRUCTURES FOR GENERATING LONG-PERSISTENT LUMINESCENCE,” all of which are incorporated herein by reference in their entirety.

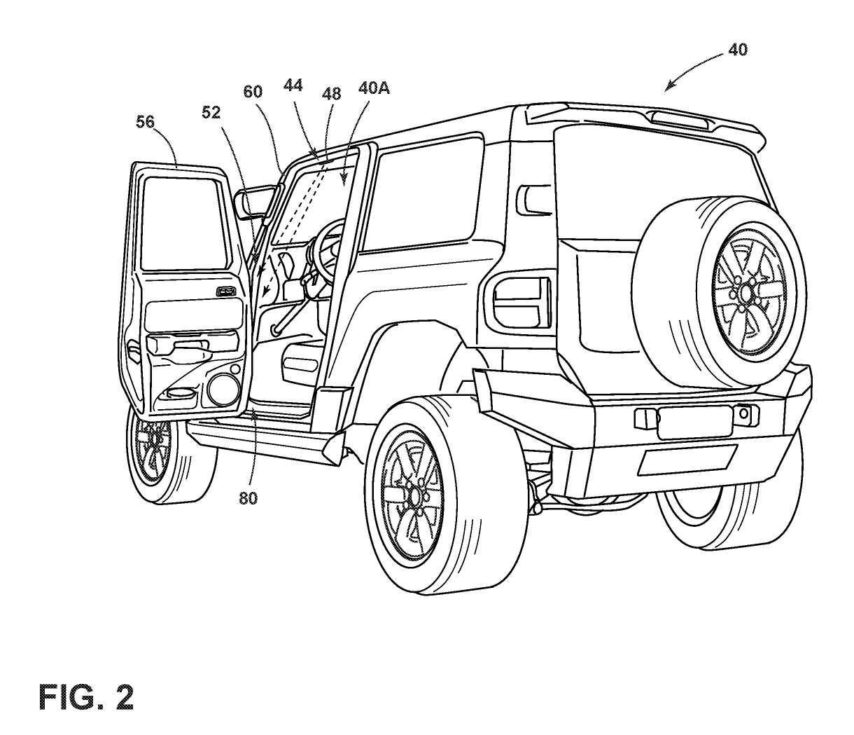

Referring now to FIGS. 2-6, a vehicle 40 includes an illumination system 44. The illumination system 44 includes a light assembly 48 configured to emit light. A hinge assembly 52 rotatably couples a door 56 to a frame 60 of the vehicle 40. The hinge assembly 52 is positioned away from the light assembly 48 and includes a frame bracket 64, a door bracket 68 and a hinge pin 72 rotatably coupling the frame and door brackets 64, 68. The photoluminescent structure 10 is positioned on the hinge assembly 52.

Referring now to FIG. 2, the vehicle 40 is capable of operation in a “doors on” (FIG. 2) configuration and a “doors off” configuration. In the doors on configuration, the vehicle 40 includes a plurality of doors 56 (e.g., driver and passenger doors) positioned around the vehicle 40 enclosing an interior 40A, or passenger cabin, of the vehicle 40. The doors 56 are operable between a closed position and an open position (FIG. 2). In essence, the vehicle 40 may be operated in a doors on configuration with the doors 56 attached to a frame of the vehicle 40 through the hinge assembly 52. In the doors off configuration, one or more of the doors 56 may be removed prior to operation (e.g., driving) of the vehicle 40 such that increased ventilation and/or a desired aesthetic appeal of the vehicle 40 is achieved.

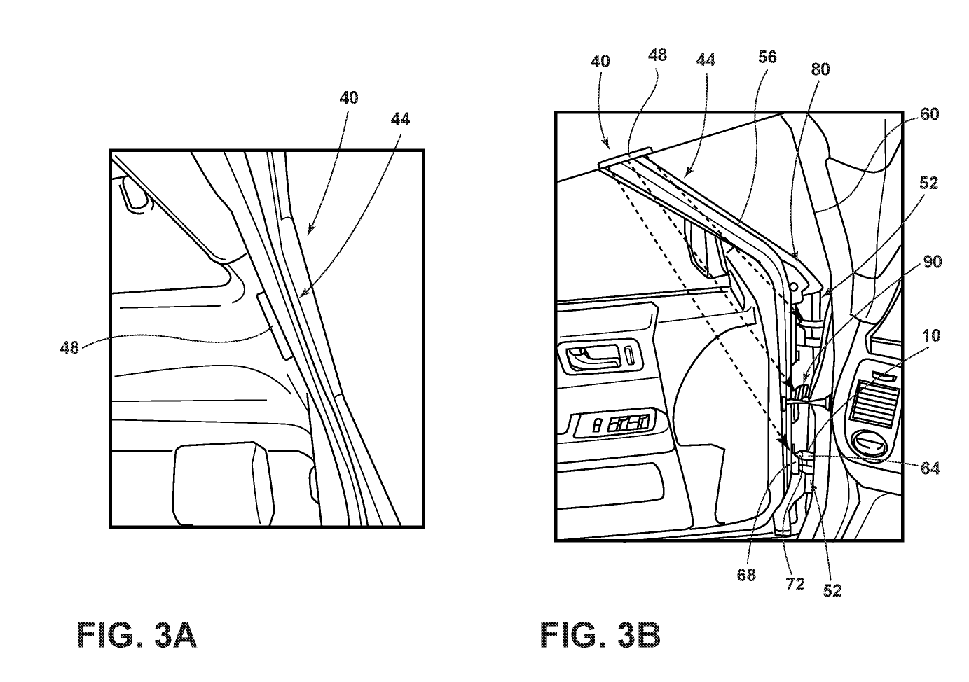

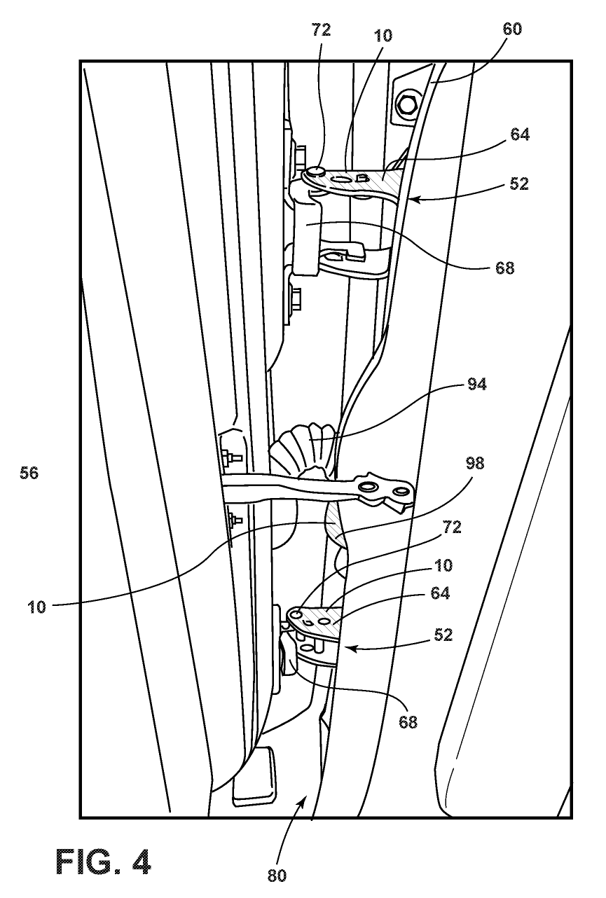

Referring now to FIGS. 3A-4, the plurality doors 56 are connected to the frame 60 proximate a door sill 80. The doors 56 are configured to be coupled with the frame 60 at the sill 80 such that the hinge assemblies 52 are substantially concealed while the doors 56 are in the closed position. It will be understood that in alternative examples of the vehicle 40, one or more of the hinge assemblies 52 may be partially and/or fully visible while the doors 56 are in the closed position. The doors 56 are connected to the frame 60 of the vehicle through one or more hinge assemblies 52 as well as an electrical connection 90. In the depicted example, the doors 56 are connected to the frame 60 through two hinge assemblies 52 (i.e., a first hinge assembly 52 and a second hinge assembly 52), but it will be understood that the doors 56 may be coupled to the vehicle 40 through a single hinge assembly 52 or through three or more hinge assemblies 52 per door 56.

As explained above, the hinge assemblies 52 allow the doors 56 to rotate between the open and closed positions. In other words, the hinge assembly 52 rotatably couples each of the vehicle doors 56 to the frame 60. The hinge assemblies 52 are positioned proximate the door sill 80. Each of the hinge assemblies 52 may include the door bracket 68, the frame bracket 64 and the hinge pin 72. The door bracket 68 is coupled to the door 56 and extends in an outwardly manner from the door 56. The frame bracket 64 is coupled to the door sill 80 and extends toward the door bracket 68. Each of the frame bracket 64 and door bracket 68 may define an aperture through which the hinge pin 72 extends. The hinge pin 72 is configured to couple the frame bracket 64 and door bracket 68 together such that the door and frame brackets 68, 64 are pivotally coupled to one another. The hinge pin 72 is capable of being removed from the door and frame brackets 68, 64 to disassemble the hinge assembly 52 such that the doors 56 may be removed from the vehicle 40.

The electrical connection 90 extends between the door 56 and the door sill 80 of the vehicle 40. The electrical connection 90 is configured to supply power and/or electrical signals to and/or from the door 56 (e.g., to provide electrical energy to power windows and locks). The electrical connection 90 is positioned proximate one or more of the hinge assemblies 52. In the depicted example, the electrical connection 90 extends between the first and second hinge assemblies 52. It will be understood that the electrical connection 90 may be placed in any location between the door 56 and the door sill 80. The electrical connection 90 includes an electrical passage 94 and a connector 98. The connector 98 may be known as a harness connector 98. The electrical passage 94 may be flexible and configured to store electrical wires which extend between the frame 60 and the door 56. The electrical connection 90 may be coupled to the door sill 80 through the connector 98. The connector 98 removably couples with the frame 60 to provide a sealed assembly for the electrical connection 90. According to at least one example, the connector 98 may be a rubber lid which snaps onto the door sill 80 or frame 60. Although described in connection with the vehicle 40 and the door sill 80, it will be understood that the connector 98 may additionally or alternatively be coupled to the door 56. Use of the electrical connection 90 incorporating the electrical passage 94 and the connector 98 may allow connection and disconnection of electrical power to the doors 56 in a reversible manner. Such a feature may be advantageous and decrease the time and effort in transitioning the vehicle 40 between the doors on and doors off configurations.

The photoluminescent structure 10 may be positioned at a plurality of points which connect the door 56 and the vehicle 40. For example, the photoluminescent structure 10 may be positioned on one or more of the hinge assemblies 52 and/or on the electrical connection 90. In examples where the photoluminescent structure 10 is positioned on the hinge assembly 52, the photoluminescent structure 10 may be positioned on the door bracket 68, the frame bracket 64 and/or the hinge pin 72. For example, the photoluminescent structure 10 is positioned on at least one of the door and the frame brackets 68, 64. Each of the door bracket 68, frame bracket 64 and/or hinge pin 72 may include a separate, discrete, photoluminescent structure 10 or a single photoluminescent structure 10 may extend across one or more of the door bracket 68, frame bracket 64 and/or hinge pin 72. In examples where the hinge assembly 52 includes two or more separate photoluminescent structures 10, each of the photoluminescent structures 10 may be configured to glow or luminesce in a different manner (e.g., in a different color, time of persistence and/or intensity). Further, the one or more photoluminescent structures 10 may be configured as any indicia (e.g., text, symbols, alphanumeric lettering, pictures) which may provide guidance to a user. In such examples, each of the photoluminescent structures 10 may form a different indicia. It will be understood that photoluminescent structures 10 positioned on one of the hinge assemblies 52 may be different (e.g., glowing a different color, type of persistence and/or intensity) than photoluminescent structures 10 positioned on other hinge assemblies 52. Similarly to the hinge assemblies 52, the electrical connection 90 may also include the photoluminescent structure 10. For example, the photoluminescent structure 10 may be positioned on the electrical passage 94 and/or the connector 98. As with the hinge assembly 52, a single photoluminescent structure 10 may extend across both the electrical passage 94 and the connector 98, or the connector 98 and electrical passage 94 may have separate photoluminescent structures 10 which may be configured to luminesce in a similar or different manner as outlined above. In examples where the electrical connection 90 and/or hinge assemblies 52 include the photoluminescent structure 10, the photoluminescent structure 10 may include one or more protective overmolds. The protective overmolds may be a transparent and/or translucent protective coating configured to reduce the environmental exposure of the photoluminescent structure 10.

The light assembly 48 is configured to emit light toward the connection between the door 56 and the door sill 80 of the vehicle 40. The vehicle 40 may include a plurality of light assemblies 48 positioned around the vehicle 40. For example, a light assembly 48 may be positioned proximate each of the door sills 80 or doors 56. In some examples, the light assembly 48 is configured to steer a beam of light to the hinge assembly 52 and/or electrical connection 90. Steering of the beam of light to illuminate hinge assemblies 52 may be performed by adjusting a lens of the light assembly 48 and/or by illuminating separate light sources of the light assembly 48. Steering of the beam of light from the light assembly 48 may be advantageous in allowing independent illumination of the hinge assemblies 52 and the electrical connection 90. For example, the light may be emitted toward a single hinge assembly 52 or electrical connection 90 such that the other hinge assemblies 52 and/or electrical connections 90 are not illuminated.

The light assembly 48 may take a variety of positions both inside and outside of the vehicle 40. For example, the light assembly 48 may be positioned proximate the door sill 80. In such examples, the light assembly 48 may be coupled with a headliner and/or associated trim pieces of the vehicle 40. In other words, the light assembly 48 may be positioned proximate a top of the door sill 80 or a door jamb. In yet other examples, the light assembly 48 may be coupled with an A-pillar and/or B-pillar of the vehicle 40. Examples of the light assembly 48 positioned on, within or proximate to the headliner of the vehicle 40 may be advantageous in providing a high vantage point with which to emit light towards the hinge assemblies 52 and/or electrical connection 90. In addition to illuminating the hinge assemblies 52 and the electrical connection 90, the light assembly 48 may be configured to provide a map light or general illumination within the vehicle 40 as well as provide a puddle lamp exterior to the vehicle 40.

The light assembly 48 is configured to emit light having a color corresponding to white, red, blue, green and/or combinations thereof. Additionally or alternatively, the light assembly 48 may be configured to emit the excitation light 24 toward the hinge assemblies 52 and/or electrical connection 90. According to various examples, the light assembly 48 may emit light configured to illuminate one or more photoluminescent structures 10 present on any component of the hinge assembly 52 and/or electrical connection 90. Such a feature may be advantageous in helping to illuminate the hinge assemblies 52 and/or electrical connection 90 while transitioning the vehicle 40 between the doors on and doors off configurations. The light assembly 48 may be configured to independently illuminate one or more of the hinge assemblies 52 and/or the connector 98. For example, the light assembly 48 may emit the excitation light 24 toward only one of the photoluminescent structures 10 (e.g., one of the hinge assemblies 52 and/or electrical connection 90) such that light assembly 48 may independently illuminate the one of the hinge assemblies 52 and/or electrical connection 90. It will be understood that the light source 48 may be configured to illuminate the hinge assemblies 52 and/or electrical connection 90 in visible light, while independently illuminating one or more of the hinge assemblies 52 and/or electrical connection 90 in the excitation light 24, or vice versa, without departing from the teachings provided herein.

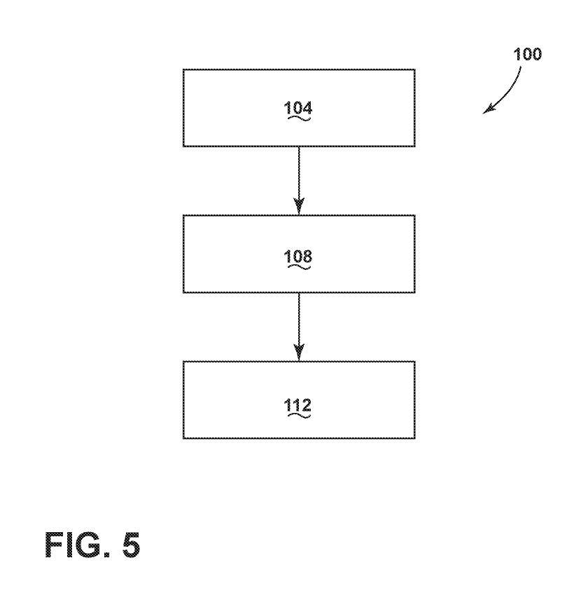

Referring now to FIG. 5, a method 100 of removing the door 56 from the vehicle 40 may include a plurality of steps. The method 100 may begin with a step 104 of transitioning the door 56 of the vehicle from the closed position to the open position. Next, a step 108 of activating the light assembly 48 to emit a beam of light may be performed. Next, a step 112 of steering the beam of light to illuminate the hinge assembly 52 coupling the door 56 and the frame 60 of the vehicle 40 may be performed. As explained above, the step of steering the beam of light to illuminate hinge assembly 52 may be performed by adjusting a lens of the light assembly 48 and/or by illuminating separate light sources of the light assembly 48. The method 100 may further include steps of illuminating a plurality of hinge assemblies 52 (e.g., a first hinge assembly 52 and a second hinge assembly 52), illuminating the electrical connector 98, exciting photoluminescent structures 10 on the hinge assembly 52 and/or disassembling the hinge assembly 52. It will be understood that although described in a particular order, the steps of the method 100 may be performed in any order, simultaneously, or have steps omitted or added without departing from the teachings provided herein.

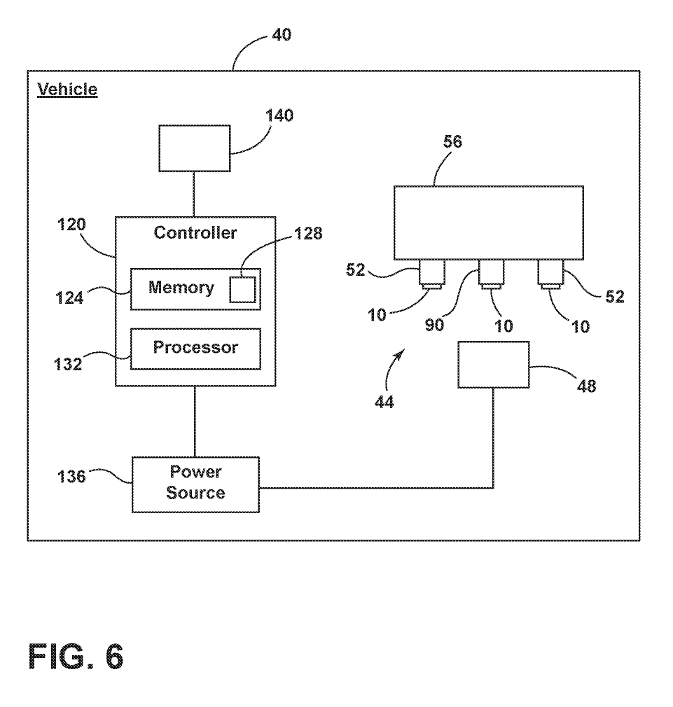

Referring now to FIG. 6, depicted is a block diagram of the vehicle 40 in which the illumination system 44 is implemented. The vehicle 40 includes a controller 120 which includes a memory 124 having a light control routine 128 contained therein that is executed by a processor 132 of the controller 120. The controller 120 may provide electrical power to the light source 48 via a power source 136 located onboard the vehicle 40. The light control routine 128 may be configured to control a variety of lighting sequences performed by the light assembly 48. The light control routine 128 may be activated by a user control interface 140. The user control interface 140 may be a human machine interface, a display, a touch screen, a switch, a button, a microphone for receiving voice commands, other interfaces and/or combinations thereof. It will be understood that in display examples of the user control interface 140, the interface 140 may provide instructions in tandem with the illumination from the light assembly 48. In a first example of the light control routine 128, the routine 128 may indicate to a user of the vehicle 40 how to remove the doors 56 from the vehicle 40. For example, the light control routine 120 may illuminate the hinge assembly 52 and/or electrical connection 90 in a predefined pattern to indicate to the user how the door 56 should be removed. For example, the light source 48 may illuminate the photoluminescent structure 10 positioned on top of the hinge pin 72 of an upper hinge assembly 52 while not illuminating any other photoluminescent structures 10. It will be understood that the light assembly 48 may or may not illuminate the other hinge assemblies 52 and/or electrical connection 90 in visible light to provide general task lighting. Once a predetermined amount of time has elapsed, or the vehicle 40 the detects that the hinge assembly 52 is disassembled (e.g., through a sensor or through interaction of the user with the user control interface 140), the light control routine 128 may instruct the light source 48 to steer or adjust the beam of light to another hinge assembly 52 and/or the electrical connection 90. In other examples, all of the hinge assemblies 52 and/or electrical connection 90 may be illuminated such that a specific hinge assembly 52 and/or electrical connection 90 is illuminated in a first color (e.g., green) to indicate the items that the user should disassemble first, while the remaining hinge assemblies 52 and electrical connections 90 are illuminated in a second color (e.g. red). As the user disassembles the hinge assemblies 52 and/or electrical connection 90, the light source 48 may change the illumination such that other hinge assemblies 52 and/or electrical connections 90 are illuminated in the first color. This process may be repeated for each door 56 of the vehicle 40.

According to a second example of the light control routine 128, the routine 128 may guide a user of the vehicle 40 on how to reconnect the door 56 to the vehicle 40. For example, once the light control routine 120 has been activated (e.g., through the user control interface 140), one or more of the hinge assemblies 52 and/or electrical connections 90 may be illuminated in a manner similar to that described above to indicate the illuminated hinge 52 or electrical connection 90 should be connected.

Use of the present disclosure may offer a variety of advantages. First, use of the presently disclosed light assembly 48 may allow illumination of multiple hinge assemblies 52 as well as the electrical connection 90 from a single assembly. Second, the light assembly 48 is able to independently, or separately, vary the illumination on the hinge assemblies 52 and/or electrical connection 90. Third, the light assembly 48 may be configured to provide a map light or general illumination within the vehicle 40 as well as provide a puddle lamp exterior to the vehicle 40 (e.g., on a ground beneath the vehicle 40). Further, in certain placements of the light assembly 48 (e.g., high door sill 80 or frame 60 locations), the light assembly 48 may illuminate in a vehicle rearward direction both inside and outside the vehicle 40. Fourth, the light assembly 48 is configured to emit both the excitation light 24 (e.g., blue or ultraviolet light) to activate the photoluminescent structures 10 on the hinge assemblies 52 and electrical connection 90, as well as white and colored light to generally illuminate the hinge assemblies 52 and electrical connection 90. As explained above, visible illumination may provide general task lighting as well as cues to the user about how to remove and/or reinstall the doors 56. Fifth, excitation of the photoluminescent structures 10 on the hinge pins 72 by the light assembly 48 may allow the hinge pins 72 to stand out regardless of day or night around the vehicle 40. Sixth, the connector 98 may be a tethered connector such that the electrical connection 90 may be decoupled or disconnected from the door sill 80 of the vehicle 40.

According to various embodiments, an illumination system includes a light assembly configured to emit light and a hinge assembly positioned away from the light assembly. The light assembly includes a frame bracket, a door bracket and a hinge pin rotatably coupling the frame and door brackets. A luminescent structure is positioned on the hinge assembly. Embodiments of the illumination system can include any one or a combination of the following features:
the luminescent structure is positioned on at least one of a door and a frame bracket;
the luminescent structure is positioned on the hinge pin;
an electrical connection positioned proximate the hinge assembly;
a second luminescent structure is positioned on a harness connector of the electrical connection;
the light assembly is configured to steer a beam of light to the hinge assembly;
a second hinge assembly positioned proximate the hinge assembly;
the hinge assembly is positioned proximate a vehicle door sill; and/or
the light assembly is coupled with a headliner of a vehicle.

According to various embodiments, a method of removing a door includes the steps of: transitioning a door of a vehicle from a closed to an open position; activating a light assembly to emit a beam of light; and steering the beam of light to illuminate a hinge assembly coupling the door and a frame of the vehicle. Embodiments of the method can include any one or a combination of the following features:
illuminating a second hinge assembly;
illuminating an electrical harness;
the light assembly is configured to independently illuminate the hinge assembly, second hinge assembly and the electrical harness;
exciting a luminescent structure positioned on the hinge assembly; and/or
disassembling the hinge assembly.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

It will be apparent to those skilled in the art that various modifications and variations can be made to the present disclosure without departing from the spirit and scope of the disclosure. Thus, it is intended that the present disclosure cover such modifications and variations provided they come within the scope of the appended claims and their equivalents. Example embodiments include the following.

What is claimed is:

1. An illumination system, comprising:
a light assembly configured to emit light;
a hinge assembly positioned away from the light assembly, comprising:
a frame bracket;
a door bracket; and
a hinge pin rotatably coupling the frame and door brackets; and
a luminescent structure positioned on the hinge assembly.

2. The illumination system of claim 1, wherein the luminescent structure is positioned on at least one of a door and a frame bracket.

3. The illumination system of claim 1, wherein the luminescent structure is positioned on the hinge pin.

4. The illumination system of claim 1, further comprising:
an electrical connection positioned proximate the hinge assembly.

5. The illumination system of claim 4, wherein a second luminescent structure is positioned on a harness connector of the electrical connection.

6. The illumination system of claim 1, wherein the light assembly is configured to steer a beam of light to the hinge assembly.

7. The illumination system of claim 1, further comprising:
a second hinge assembly positioned proximate the hinge assembly.

8. The illumination system of claim 1, wherein the hinge assembly is positioned proximate a vehicle door sill.

9. The illumination system of claim 1, wherein the light assembly is coupled with a headliner of a vehicle.

10. A vehicle, comprising:
a hinge assembly rotatably coupling a vehicle door to a frame of the vehicle;
a photoluminescent structure positioned on the hinge assembly; and
a light assembly positioned proximate the door and configured to illuminate the photoluminescent structure.

11. The vehicle of claim 10, wherein the light assembly is configured to steer a beam of light to the photoluminescent structure.

12. The vehicle of claim 10, wherein a second luminescent structure is positioned on a harness connector of an electrical connection.

13. The vehicle of claim 12, wherein the light assembly is configured to independently illuminate the hinge assembly and the harness connector.

14. The vehicle of claim 10, wherein the light assembly is positioned proximate a top of a door sill.

15. A method of removing a door, comprising the steps:
transitioning a door of a vehicle from a closed to an open position;
activating a light assembly to emit a beam of light; and
steering the beam of light to illuminate a hinge assembly coupling the door and a frame of the vehicle.

16. The method of claim 15, further comprising the step of:
illuminating a second hinge assembly.

17. The method of claim 16, further comprising the step of:
illuminating an electrical harness.

18. The method of claim 17, wherein the light assembly is configured to independently illuminate the hinge assembly, second hinge assembly and the electrical harness.

19. The method of claim 15, further comprising the step:
exciting a luminescent structure positioned on the hinge assembly.

20. The method of claim 15, further comprising the step of:
disassembling the hinge assembly.
